(19) United States
(12) Patent Application Publication
(10) Pub. No.: US 2008/0221959 A1
(43) Pub. Date: Sep. 11, 2008

(54) System and architecture for managing distributed design chains

(75) Inventors: Gopinath Ganapathy, Redwood City, CA (US); Rajesh Iyer, Chennai (IN); Ravi Krishnamurthy, Santa Clara, CA (US); Muthu Krishnan, Alwarpet (IN); Venkatesh Balasubramanian, Chennai (IN); Ramasubramaniam Lakshminarayan, Plano, TX (US)

Correspondence Address: PERKINS COIE LLP, P.O. BOX 1208, SEATTLE, WA, 98111-1208, US

(73) Assignee: CollabNet, Inc., Brisbane, CA (US)

(21) Appl. No.: 11/974,209

(22) Filed: Oct. 10, 2007

Related U.S. Application Data
(62) Division of application No. 10/786,346, filed on Feb. 24, 2004.
(60) Provisional application No. 60/449,750, filed on Feb. 24, 2003.

(51) Int. Cl. G06Q 90/00

(52) U.S. Cl. 705/8

(57) ABSTRACT

Systems, architectures, and data structures are described which are used to manage distributed design chains, specifically for domains in which data reside in multiple applications and are linked through complex interrelationships. The design chains or design networks integrated by the invention may include multiple companies in multiple sites collaborating to design and develop a new product. The invention is intended to integrate seamlessly and transparently with existing, diverse legacy applications, which include inter-linked data relevant to the design, thereby addressing the needs identified above.

This application is a divisional patent application of U.S. application Ser. No. 10/786,346, filed Feb. 24, 2004, which application claims priority to U.S. Provisional Application 60/449,750, entitled “System and Method for Implementing Design Chains”, filed Feb. 24, 2003. These applications are hereby incorporated by reference in its entirety.

### FIELD OF THE INVENTION

The invention relates to the field of software. In particular, the invention relates to enterprise software which integrates information from disparate elements to support the management of product design.

### DESCRIPTION OF THE RELATED ART

Collaborative design projects are multiplying in complexity. In industries such as hardware and software design, such projects may involve thousands of collaborators, dispersed over diverse geographic locales and time zones. Design and development efforts may involve multiple companies as well, further balkanizing the design process. Furthermore, information necessary to track the status of such projects may reside in numerous legacy applications which are not intended for interoperation, including human resources, accounting, and Enterprise Resource Planning software, as well as more conventional design software, such as issue tracking tools, project tracking tools, electronic design tools, e-mail correspondences, and product requirement documents. Complex interrelationships often exist amongst the relevant data resident in these diverse tools, further complicating efforts to obtain a consistent view of the design process. Accordingly, there is a need for:
Natural support for a truly distributed project design environment integrating distributed applications and data, and supporting distributed decision-making.
Integration of user-preferred applications in the design process, transparently across organizations and geographies.
A globalization engine that does not duplicate the data present in user-preferred applications across the Internet, but which instead maintains meta-data and links to information present in other design-chain applications.
Built-in application integration and application transport across local and wide-area networks.
Rapid plug-n-play of design-chain participants.
Uniform adapter framework for supporting a wide variety of data sources.

These and other features desirable in design chain management are addressed by the present invention.

### SUMMARY

The invention comprises systems, architectures, and data structures used to manage distributed design chains, specifically for domains in which data reside in multiple applications and are linked through complex interrelationships. The design chains or design networks integrated by the invention may include multiple companies in multiple sites collaborating to design and develop a new product. The invention is intended to integrate seamlessly and transparently with existing, diverse legacy applications, which include inter-linked data relevant to the design, thereby addressing the needs identified above.

The information integrated by the invention may reside in various human and application sources, including pre-existing and legacy applications for domains such as human resources, accounting, Enterprise Resource Planning (ERP), Electronic Design Automation (EDA), existing project planning and tracking tools, and other diverse sources. This integration is accomplished by capturing relationships between data in disparate sources, aggregating key meta-data, and publishing reports based on the information needs of different users. The invention responds to events such as user queries by retrieving and integrating data from these disparate resources in real-time, with a high degree of confidence. Embodiments of the invention also capture the history of the design process, and alert users to the occurrence of exceptions, discrepancies in data, as well as other events in the design chain that merit real-time alerts. By integrating diverse data sources, the invention allows data to reside in best-of-breed, user-preferred applications. Data structures and methods used to facilitate such integration are further described herein.

### BRIEF DESCRIPTION OF THE FIGURES

FIG. 1 illustrates a system and architecture of the invention according to embodiments of the invention.

FIG. 2 illustrates screen shots used in embodiments of the invention.

FIG. 3a illustrates an example of a viewflow according to embodiments of the invention.

FIG. 3b illustrates multiple viewflows according to embodiments of the invention.

FIG. 4 illustrates an example query according to embodiments of the invention.

FIG. 5 illustrates an architecture for processing viewflows according to embodiments of the invention.

### DETAILED DESCRIPTION

The examples and embodiments presented herein are for illustrative purposes only; many modifications, equivalents, and alternatives will be readily apparent to those skilled in the art.

### Integration of Disparate Applications for Monitoring Design Chains

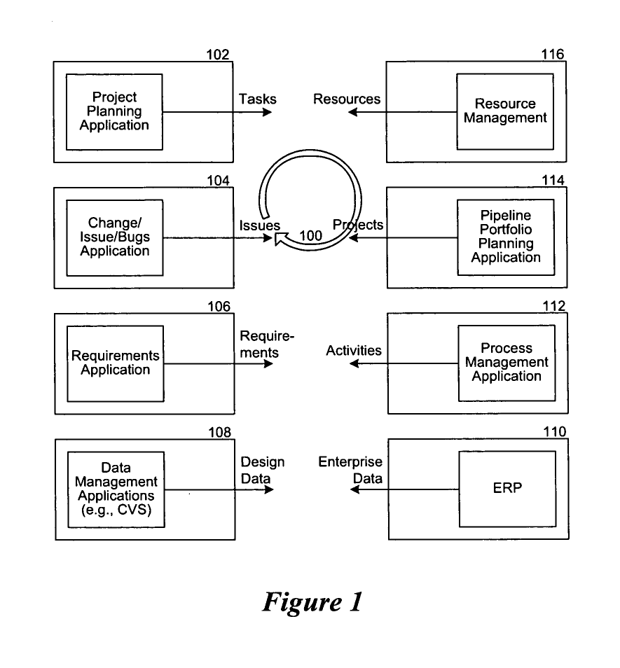

The invention includes a system 100 for querying, modeling, and monitoring disparate sets of point applications to monitor distributed design chains, as illustrated schematically in FIG. 1. The point applications 102-116 may comprise disparate sources of information such as time/billing applications, project planning applications, EDA tools, design documents, issue-tracking software, code registries, and ERP systems. Through querying and/or real-time monitoring of these systems, the invention provides real-time views of the design process; warnings of inconsistencies amongst design data, failures to meet schedules or targets, or other time-sensitive events in the design process; corrections to design failures; and other types of support for the design process.

Complex relationships exist amongst the different atomic elements in the system 100. By way of illustrative, non-limiting example, issues contained in an issue tracker 104 could relate to a task in a project plan 102. Similarly, design data 108 may relate to a particular task in a project plan 102. Other examples of relationships between data amongst the point tools 102-116 which occur in the design process shall be readily apparent to those skilled in the art.

### Data Structures Used in the Design Chain Management System: “Data Objects”

To facilitate the services described herein, the invention includes a novel methods and data structures for persisting data by defining schemas “on-the-fly”, and using generic store, retrieve and update methods to persist data recorded in such schemas. Embodiments of the invention support an abstracted service that implements such capabilities and which can be run under an application server accessible to any clients 102 116 integrated by the system 100.

In embodiments of the invention, the core platform 100 of the design management system operates by the manipulation of generic objects that contain data and meta-data, which are termed “Data Objects” herein. Data Objects facilitate the communication and manipulation of data within the design management system 100. In embodiments of the invention, data objects are recursive structures which may further include one or more of the following fields or features:
In some embodiments of the invention, Data Objects may be strongly typed, with each Data Object listing its type in a corresponding field.
One or more name-value pairs, or attributes. In embodiments of the invention, each such attribute corresponds to a type.
One or more additional Data Objects recursively embedded in a parent Data Object.
Data corresponding to the type of the Data Object.

In embodiments of the invention, Data Objects may be created by reference to, or alternatively, transformed into, corresponding XML schemas. As an illustrative, non-limiting example, an XML schema for a Data Object for a project “task” (further defined herein) is presented in Table 1 below:

TABLE 1
Description of Task Data Object

| Attribute | Type |
|---|---|
| Planned Data | DataObject |
| Expected Data | DataObject |
| Type | String (Planned/Issue/Misc.) |
| Resources | String[ ] |
| Name | String |
| UniqueID | Int |
| Planned Effort | Float |
| Expected Effort | Float |

The “Type” attribute in the Task Data Object is of type “String” and admits of three values: “Planned,” “Issue,” and “Misc.”. The “Task” Data Object of Table 1 further includes two additional, recursively embedded Data Objects for “Planned Data” and “Expected Data.” These recursively embedded objects, which are presented for illustrative purposes in Tables 2 and 3 below, contain further attributes as shown therein:

TABLE 2
Task→Planned Data DataObject

| Attribute | Type |
|---|---|
| Planned Start Date | Date |
| Planned End Date | Date |

TABLE 3
Task→Expected Data DataObject

| Attribute | Type |
|---|---|
| Expected Start Date | Date |
| Expected End Date | Date |

Embodiments of the invention further include distinct types of data objects, including “System” Data Objects and “User” Data Objects. System Data Objects store system related properties and usually derive from a custom class. “UserData” objects typically represent useful pieces of information about the design chain. In some embodiments, such User Data Objects are configured on-the-fly. By way of illustrative example, tables 4, 5, and 6 illustrate XML schemas for “Tasks”, “Planned Data”, and “Expected Data”, each comprising an important type of data object in the design chain management process and further described below.

TABLE 4
Task.xml

```
<?xml version=“1.0”?>
<UserDOTypeList>
  <UserAttrib>
    <DOType>TASK</DOType>
    <Descr>Container for all the project task status detail info</Descr>
    <Attrib>
      <AttribName>Type</AttribName>
      <AttribClass>String</AttribClass>
    </Attrib>
    <Attrib>
      <AttribName>Resources</AttribName>
      <AttribClass>StringArray</AttribClass>
    </Attrib>
    <Attrib>
      <AttribName>Name</AttribName>
      <AttribClass>String</AttribClass>
    </Attrib>
    <Attrib>
      <AttribName>UniqueID</AttribName>
      <AttribClass>Int32</AttribClass>
    </Attrib>
    <Attrib>
      <AttribName>PlannedEffort</AttribName>
      <AttribClass>Long</AttribClass>
    </Attrib>
    <Attrib>
      <AttribName>ExpectedEffort</AttribName>
      <AttribClass>Long</AttribClass>
    </Attrib>
    <Attrib>
      <AttribName>PlannedData</AttribName>
      <AttribClass>PLANNED_DATA</AttribClass>
    </Attrib>
    <Attrib>
      <AttribName>ExpectedData</AttribName>
      <AttribClass>EXPECTED_DATA</AttribClass>
    </Attrib>
  </UserAttrib>
</UserDOTypeList>
```

TABLE 5
PlannedData.xml

```
<?xml version=“1.0”?>
<UserDOTypeList>
  <UserAttrib>
    <DOType>PLANNED_DATA</DOType>
    <Attrib>
      <AttribName>PlannedStartDate</AttribName>
      <AttribClass>Date</AttribClass>
    </Attrib>
    <Attrib>
      <AttribName>PlannedEndDate</AttribName>
      <AttribClass>Date</AttribClass>
    </Attrib>
  </UserAttrib>
</UserDOTypeList>
```

TABLE 6
ExpectedData.xml

```
<?xml version=“1.0”?>
<UserDOTypeList>
  <UserAttrib>
    <DOType>EXPECTED_DATA</DOType>
    <Attrib>
      <AttribName>ExpectedStartDate</AttribName>
      <AttribClass>Date</AttribClass>
    </Attrib>
    <Attrib>
      <AttribName>ExpectedEndDate</AttribName>
      <AttribClass>Date</AttribClass>
    </Attrib>
  </UserAttrib>
</UserDOTypeList>
```

Examples of methods used in conjunction with such data objects, according to embodiments of the invention, are further described in U.S. Provisional Application 60/449,750, filed Feb. 24, 2003, entitled “System and Method for Implementing Design Chains”, which is hereby incorporated by reference in its entirety.

### Illustrative Example: Tasks

“Tasks” are defined as atomic units of work that a resource (typically a person) performs in the design chain. Tasks are recursively divided into sub-tasks; the entire design project can be regarded as equivalent to one large “roll-up task”. Tasks generally have one or more of the following characteristics:
Tasks originate from various sources, including project plans 102 (Planned Tasks), random work that shows up on an interrupt basis (Misc.), and tasks that come from an issue/bug-tracker (IssueTasks) 104.
Planned tasks have planned start and completion dates which are maintained in a Project Planning application 102.
Planned tasks have expected or actual completion dates which are typically captured in a Project Tracking application or process.

A Task DataObject may be defined as depicted in Table 7 as follows:

TABLE 7
Description of Task Data Object

| Attribute | Type |
|---|---|
| Planned Data | DataObject |
| Expected Data | DataObject |
| Type | String (Planned/Issue/Misc.) |
| Resources | String[ ] |
| Name | String |
| UniqueID | Int |
| Planned Effort | Float |
| Expected Effort | Float |

In the embodiment illustrated above, the Task type attribute is of type String and admits of three values: “Planned,” “Issue,” and “Misc.”. Planned Data and Expected Data contain further attributes which are defined in tables 8 and 9 below. A data object for resources comprises a set of resource names who are planned to (or have already worked on) this task.

TABLE 8
Task→Planned Data DataObject

| Attribute | Type |
|---|---|
| Planned Start Date | Date |
| Planned End Date | Date |

TABLE 9
Task→Expected Data DataObject

| Attribute | Type |
|---|---|
| Expected Start Date | Date |
| Expected End Date | Date |

TABLE 10
Resource Data Object

| Attribute | Type |
|---|---|
| Name | String |
| Projects | String[ ] |
| Allocations | Float[ ] |
| Planned Utilization | Float[ ] |
| Actual Utilization | Float[ ] |

Each resource has a name and may be allocated to multiple projects.

### Illustrative Example: Data Aggregation and Role-Specific Views

To further illustrate the use of the data objects described above, presented herein are non-limiting examples of data-aggregation and generation of role-specific views according to embodiments of the invention. More specifically, the examples herein pertain to views of the design management system referred to as a ToDoList and StatusEntry, both of which are typically provided to engineers/individual contributors. The steps involved in generating these views include the following:
A set of projects are defined in the system. A set of “domains” are defined which delineate responsibilities within the design management system. Domains may be further defined as projects, super-projects, portfolios and functions.
Users are added to the system and each one is mapped to one or more domains (projects).
Project plans are uploaded for some or all of the domains.
Users are assigned to tasks within the project plan.

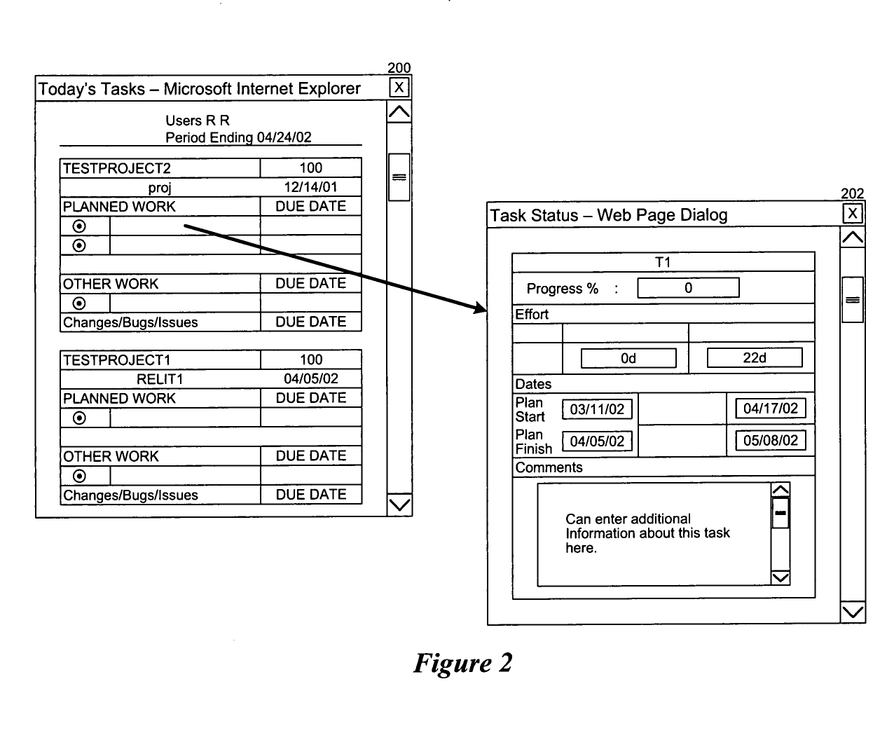

The ToDoList/Status Entry views contain an integrated view of all the tasks on which a resource is expected to work. FIG. 2 illustrates the generation of a ToDoList 200 and a corresponding tracking page 202; the generation of the Status Entry page is similar but for differences in the respective user interfaces. Each item in the ToDoList 200 corresponds to a task in the design project, which have the attributes described for tasks above.

The design chain management system 100 is aware of the three kinds of tasks on which a user works, as described above, as well as the data source from which to extract each type of task. For example, for Tasks of type “Planned,” the planned data and the resource assignment are extracted from an appropriate project management file 102. The expected values may come from numerous sources, non-limiting examples of which include email status reports; other sources for expected values in the design process will be readily apparent to those skilled in the art. In embodiments of the invention, the task in the two sources are related by means of the Unique ID which uniquely identifies a task.

In embodiments of the invention, the ToDoList is generated through execution of one or more of the following steps:
The Core Platform 100 of the design chain management system starts with the resource Name and an ID of a user who is requesting their ToDoList.
The management system 100 determines which projects this resource belongs to.
For each of the projects, the management system 100 extracts the plan Task DataObjects from the corresponding project plan and displays a corresponding Task Name and a Plan end date.
Typically, miscellaneous tasks have been entered by the resource. These tasks are maintained in a database for the management system 100 against the project, and are retrieved from this database for processing.
Issues are maintained in a separate issue tracker, and issues corresponding to a particular user are created and displayed in the ToDoList.
This process is repeated for each of the projects to which the given user is assigned.
In embodiments of the invention, tasks may be highlighted or color coded to reflect priority or otherwise draw the user's attention.

The task tracking page 202 allows the user to input information regarding the task, and provides the user with further details with respect to the task including the planned effort, planned start date, and other parameters.

Embodiments of the invention also include techniques for highlighting discrepancies in the design chain, by use of a “Schedule screen” 200, which relates planned and expected values for the task atomic elements in a project and highlights identified discrepancies therein. In some embodiments, this view 200 is generated by extracting all planned tasks for the project from the Project Planning application 102; in some embodiments, discrepancies may be color-coded. Specific rules are then applied to highlight discrepancies. By way of illustrative, non-limiting example, a typical rule for a task is presented as follows:

If(expected_end_date −plan_end_date) > x% color code red;
If(expected_end_date −plan_end_date) <= 0 color code green;
If(expected_end_date<today) and task_completion_percent<100% =>
color code red;
Color code yellow otherwise

As will be apparent to those skilled in the art, similar rules may be applied to the planned and expected effort fields as well. Other rules for identifying discrepancies between planned and expected parameters in the product design chain shall be readily apparent to those skilled in the art.

### Caching and Storing History of the Design Project

Embodiments of the invention allow a history to be stored of a project design. In some embodiments, snapshots may be taken and recorded through the use of particular data objects, such as the “Snapshot” and “Project” data objects depicted in tables 10a and 10b below:

TABLE 10a
Project Snapshot DataObject

| | |
|---|---|
| Planned Start | Date |
| Planned End | Date |
| Expected Start | Date |
| Expected End | Date |
| Planned Effort | Float |
| Expected Effort | Float |
| Planned Cost | Float |
| Expected Cost | Float |

TABLE 10b
Project DataObject

| | |
|---|---|
| Name | String |
| Owner | String (Named User on system) |
| Project Snapshot | DataObject |
| Historical | DataObject[ ] (Set of snapshots) |
| Task | DataObject[ ] (Set of tasks) |

### Synopsis of Procedures for Generating Views

The procedures for generating views as described thus far may be summarized as follows:
Define atomic elements and properties using either a fixed schema or an on-the-fly schema.
Extract properties of each atomic element from respective application, by use of Viewflows, as further described herein.
Apply rules on these properties to identify discrepancies.
Generate views of interest based on these properties.
Cache data for faster retrieval.
Store historical meta-data for providing trends and historical information.

### Data Structures and Architecture for Implementation of Design Chain Management System Cells and Viewflows

The design chain management system of the present invention employ a core object model and architecture, employing “cells” and “viewflows” as further described herein.

### Core Object Model: Cells

The invention builds on the “data objects” described earlier to implement “Cells” and “ViewFlows,” which facilitate the core platform 100 of the design management system. Cells define specific information of interest in the design chain and contain viewflows. A viewflow, in turn, contains the control information to generate its parent cell. The viewflow may further combine different views of the system, by use of rules which generate more complex views. While a design flows towards completion, views flow through the design chain and provide visibility and control over the design flow. The information in the viewflow may be configured using XML files and may further include data and rules to generate a particular cell.

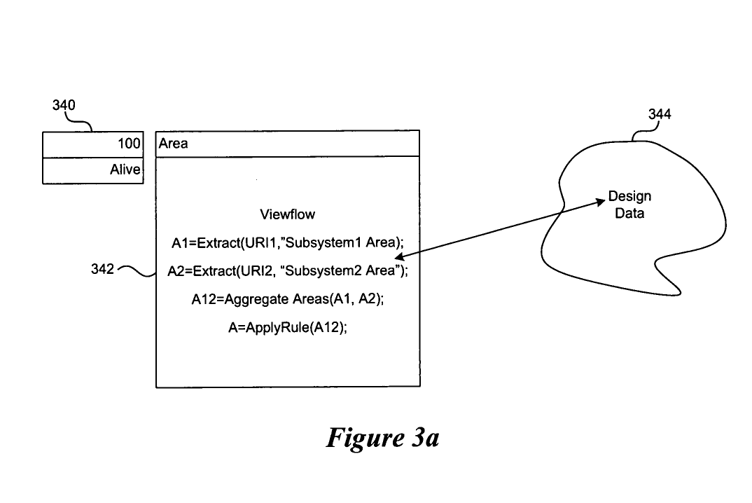

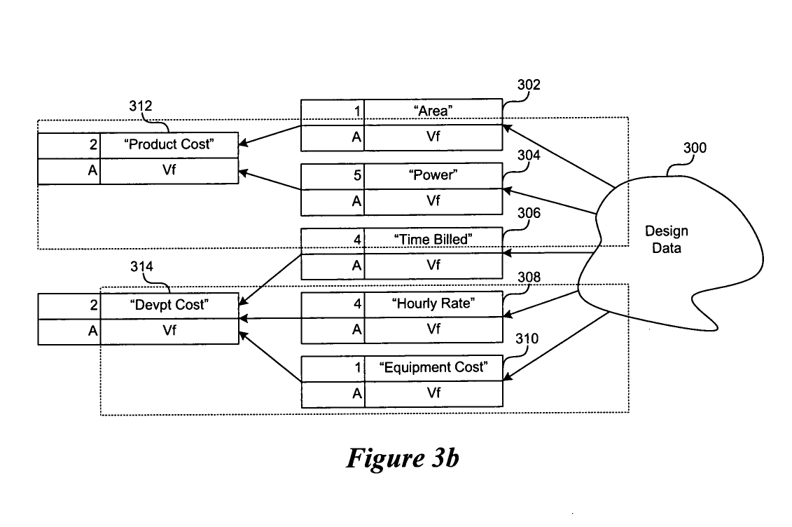

These concepts are illustrated by the non-limiting example depicted in FIG. 3a, which involves the determination of an “area” in the design of an integrated circuit. The viewflow 342 includes operators used to extract and aggregate information from other cells. To elaborate, the “area” cell 340 embeds an instruction sequence 342 to (1) extract the area information from two sources 344, (2) aggregate such information, and (3) fire a compare rule to check actual area versus the desired area (i.e., the area specified in the design goal). In embodiments of the invention, the user may be subsequently alerted based on pre-determined thresholds.

FIG. 3b illustrates an example of the combination of simple cells 302-310 to generate complex cells 312 314 according to embodiments of the invention. The design information for generating the cells 302-314 reside in this comes from EDA applications (Area, Power), a timecard system (Time billed), an HR system (Hourly rate) and a Purchasing System (Equipment Cost). These are combined to estimate Development Cost 314 and Product Cost 312 by use of instructions and rules encoded in the core platform 100 of the invention. In some embodiments, atomic instructions supported by the design management system include “Extract,” “Aggregate”, “Getfile,” and “ApplyRule” primitives. In some embodiments, the cell generation process may be recursive.

### Core Object Model: ViewFlows

ViewFlows comprise sequences of nodes (which, in turn, may comprise instructions or Viewflows) which are executed in a defined order. Such nodes allow branching as well as evaluation of Boolean rule results to elect a subsequent node in an execution path; in embodiments of the invention, the nodes in a viewflow are arranged in a directed acyclic graph. In embodiments of the invention, a node in a viewflow may have one or more input nodes, and no more than one output node.

In embodiments of the invention, each such node indicates one or more of the following:

The peer to execute the node.

The resources (files/databases) to be used for execution.

Input and output Data Object Types.

Generic user definable parameters.

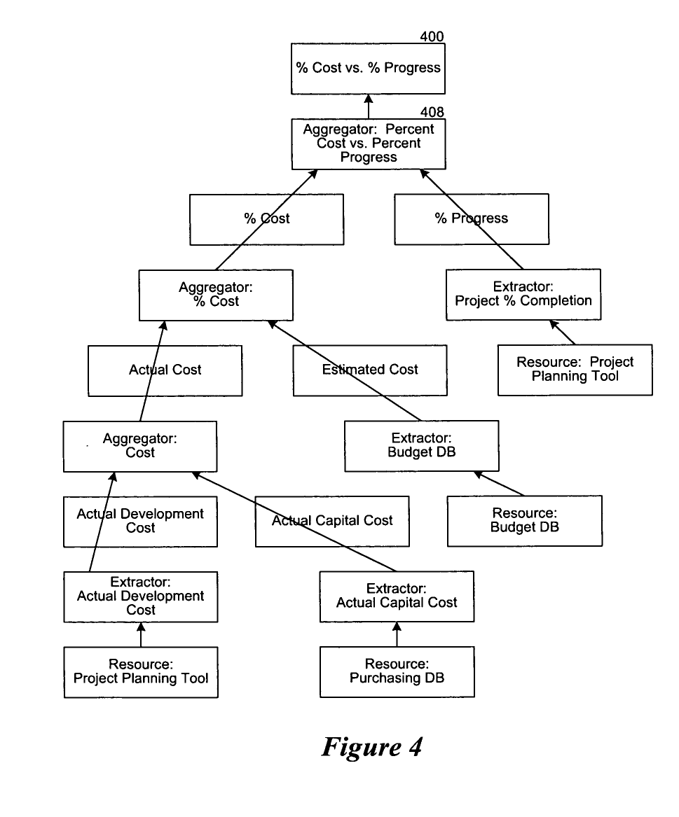

As an illustrative, non-limiting example, FIG. 4 depicts a viewflow 400 which compares the percentage of the total cost of a design project at a point in time to the progress of the design at that point in time 408.

An example of a schema encoding the Viewflow 400 is presented in Table 10c.

```
TABLE 10c
<?xml version=“1.0” encoding=“UTF-8”?>
<!-- edited with XML Spy v3.5 NT (http://www.xmlspy.com) by suthasankar (Enlite) -->
<Viewflow>
    <ViewflowName>cost vs progress(for product)</ViewflowName>
    <ViewflowNode>
        <NodeNo>1</NodeNo>
        <NodeType>Instruction</NodeType>
        <VfInstrName>Get Dev Cost From MsProjectFile</VfInstrName>
        <InstrParam>
            <ParamType>R</ParamType>
            <ParamDataType>enlite.Core
Platform.dataobjects.ResourceDO</ParamDataType>
        </InstrParam>
        <InstrParam>
            <ParamType>O</ParamType>
            <ParamDataType>ACTUAL_DEV_COST</ParamDataType>
        </InstrParam>
        <ExecClass>enlite.Core Platform.instruction.ExtractorMsProject</ExecClass>
    </ViewflowNode>
    <ViewflowNode>
        <NodeNo>2</NodeNo>
        <NodeType>Instruction</NodeType>
        <VfInstrName>Get Cap Cost From Purchasing Table</VfInstrName>
        <InstrParam>
            <ParamType>R</ParamType>
            <ParamDataType>enlite.Core
Platform.dataobjects.ResourceDO</ParamDataType>
        </InstrParam>
        <InstrParam>
            <ParamType>D</ParamType>
            <ParamDataType>enlite.Core
Platform.dataobjects.DomainDO</ParamDataType>
        </InstrParam>
        <ExecClass>enlite.Core
Platform.instruction.ExtractorPurchasingDBActCapCost</ExecClass>
    </ViewflowNode>
    <ViewflowNode>
        <NodeNo>3</NodeNo>
        <NodeType>Instruction</NodeType>
        <VfInstrName>Get Estimated Product Cost From Budgeting
Table</VfInstrName>
        <InstrParam>
            <ParamType>R</ParamType>
            <ParamDataType>enlite.Core
Platform.dataobjects.ResourceDO</ParamDataType>
        </InstrParam>
        <InstrParam>
            <ParamType>D</ParamType>
            <ParamDataType>enlite.Core
Platform.dataobjects.DomainDO</ParamDataType>
        </InstrParam>
        <ExecClass>enlite.Core
Platform.instruction.ExtractorBudgetDBEstcost</ExecClass>
    </ViewflowNode>
    <ViewflowNode>
        <NodeNo>4</NodeNo>
        <NodeType>Instruction</NodeType>
        <VfInstrName>Get percent complete from MS Project File</VfInstrName>
        <InstrParam>
            <ParamType>R</ParamType>
            <ParamDataType>enlite.Core
Platform.dataobjects.ResourceDO</ParamDataType>
        </InstrParam>
        <InstrParam>
            <ParamType>O</ParamType>
            <ParamDataType>PERCENT_PROGRESS</ParamDataType>
        </InstrParam>
        <ExecClass>enlite.Core Platform.instruction.ExtractorMsProject</ExecClass>
    </ViewflowNode>
    <ViewflowNode>
        <NodeNo>5</NodeNo>
        <NodeType>Instruction</NodeType>
        <VfInstrName>Aggregate Actual Cost</VfInstrName>
        <InstrParam>
            <ParamType>I</ParamType>
            <ParamDataType>ACTUAL_DEV_COST</ParamDataType>
        </InstrParam>
        <InstrParam>
            <ParamType>I</ParamType>
            <ParamDataType>ACTUAL_CAP_COST</ParamDataType>
        </InstrParam>
        <InstrParam>
            <ParamType>O</ParamType>
            <ParamDataType>ACTUAL_COST</ParamDataType>
        </InstrParam>
    <PredecessorNode>
      <NodeNo>1</NodeNo>
    </PredecessorNode>
    <PredecessorNode>
      <NodeNo>1</NodeNo>
    </PredecessorNode>
        <ExecClass>enlite.Core Platform.instruction.AggregatorSum</ExecClass>
    </ViewflowNode>
    <ViewflowNode>
        <NodeNo>6</NodeNo>
        <NodeType>Instruction</NodeType>
        <VfInstrName>Calculate Percent Cost</VfInstrName>
        <InstrParam>
            <ParamType>I</ParamType>
            <ParamDataType>ACTUAL_COST</ParamDataType>
        </InstrParam>
        <InstrParam>
            <ParamType>I</ParamType>
            <ParamDataType>ESTIMATED_COST</ParamDataType>
        </InstrParam>
        <InstrParam>
            <ParamType>O</ParamType>
            <ParamDataType>PERCENT_COST</ParamDataType>
        </InstrParam>
    <PredecessorNode>
      <NodeNo>3</NodeNo>
    </PredecessorNode>
    <PredecessorNode>
      <NodeNo>5</NodeNo>
    </PredecessorNode>
        <ExecClass>enlite.Core Platform.instruction.AbstractorPercent</ExecClass>
    </ViewflowNode>
    <ViewflowNode>
        <NodeNo>7</NodeNo>
        <NodeType>Instruction</NodeType>
        <VfInstrName>Aggregate %Cost and %Progress</VfInstrName>
        <InstrParam>
            <ParamType>I</ParamType>
            <ParamDataType>PERCENT_COST</ParamDataType>
        </InstrParam>
        <InstrParam>
            <ParamType>I</ParamType>
            <ParamDataType>PERCENT_PROGRESS</ParamDataType>
        </InstrParam>
        <InstrParam>
            <ParamType>O</ParamType>
    <ParamDataType>PERCENT_COST_VS_PROGRESS</ParamDataType>
        </InstrParam>
    <PredecessorNode>
      <NodeNo>4</NodeNo>
        </PredecessorNode>
    <PredecessorNode>
      <NodeNo>6</NodeNo>
    </PredecessorNode>
        <ExecClass>enlite.Core Platform.instruction.AggregatorSimple</ExecClass>
    </ViewflowNode>
</Viewflow>
```

In this example, the viewflow has 7 nodes, all of which are instructions. Each instruction has multiple input parameters which are indexed by a ParamType indicating its type as follows:
“D”: Indicates a Domain typically provided by a ViewFlow sequencer; this parameter indicates which project against which to execute the instruction.
“I” indicates an input DataObject provided by a sequencer from previous instructions in the sequence.
“O” indicates an output dataobject provided by the instruction.

Resources employed by a viewflow may also be configured through an XML-based schema. A non-limiting example of such a schema is presented in Table 11.

```
TABLE 11
<?xml version=“1.0” encoding=“UTF-8”?>
<!-- edited with XML Spy v3.5 NT (http://www.xmlspy.com) by suthasankar (Enlite) -->
<ResourceList>
    <Resource>
        <ResourceName>DSP_MSPROJECT_FILE</ResourceName>
        <ResourceType>PROJECT_ODBC_CONN_STRING</ResourceType>
        <ResourceProperty>
            <PropertyType>FILENAME</PropertyType>
            <PropertyValue>c:/enlite/resource/project/Dsp.mdb</PropertyValue>
        </ResourceProperty>
        <Domain>DSP</Domain>
    </Resource>
    <Resource>
        <ResourceName>R&amp;D_PURCHASING_DB_TEXT_FILE</ResourceName>
        <ResourceType>DB-TEXT</ResourceType>
        <ResourceProperty>
            <PropertyType>COMP1.InputFileName</PropertyType>
    <PropertyValue>c:/enlite/resource/erp/PurchaseCapCost.txt</PropertyValue>
        </ResourceProperty>
        <ResourceProperty>
            <PropertyType>COMP1.Type</PropertyType>
            <PropertyValue>ACTUAL_CAP_COST</PropertyValue>
        </ResourceProperty>
        <ResourceProperty>
            <PropertyType>ADAPTOR_ID</PropertyType>
            <PropertyValue>1</PropertyValue>
        </ResourceProperty>
        <ResourceProperty>
            <PropertyType>COMP1.NumAttributes</PropertyType>
            <PropertyValue>2</PropertyValue>
        </ResourceProperty>
        <ResourceProperty>
            <PropertyType>SINK_NAME</PropertyType>
            <PropertyValue>COMP2</PropertyValue>
        </ResourceProperty>
        <ResourceProperty>
            <PropertyType>OUTPUT_DOTYPENAME</PropertyType>
            <PropertyValue>ACTUAL_CAP_COST</PropertyValue>
        </ResourceProperty>
        <Domain>DSP</Domain>
    </Resource>
    <Resource>
        <ResourceName>R&amp;D_BUDGET_DB_TEXT_FILE</ResourceName>
        <ResourceType>DB-TEXT</ResourceType>
        <ResourceProperty>
            <PropertyType>COMP1.InputFileName</PropertyType>
    <PropertyValue>c:/enlite/resource/erp/BudgetProjectCost.txt</PropertyValue>
        </ResourceProperty>
        <ResourceProperty>
            <PropertyType>COMP1.Type</PropertyType>
            <PropertyValue>ESTIMATED_COST</PropertyValue>
        </ResourceProperty>
        <ResourceProperty>
            <PropertyType>ADAPTOR_ID</PropertyType>
            <PropertyValue>1</PropertyValue>
        </ResourceProperty>
        <ResourceProperty>
            <PropertyType>COMP1.NumAttributes</PropertyType>
            <PropertyValue>2</PropertyValue>
        </ResourceProperty>
        <ResourceProperty>
            <PropertyType>SINK_NAME</PropertyType>
            <PropertyValue>COMP2</PropertyValue>
        </ResourceProperty>
        <ResourceProperty>
            <PropertyType>OUTPUT_DOTYPENAME</PropertyType>
            <PropertyValue>ESTIMATED_COST</PropertyValue>
        </ResourceProperty>
        <Domain>DSP</Domain>
    </Resource>
    <Resource>
        <ResourceName>DSP_MSPROJECT_FILE</ResourceName>
        <ResourceType>PROJECT_ODBC_CONN_STRING</ResourceType>
        <ResourceProperty>
            <PropertyType>FILENAME</PropertyType>
    <PropertyValue>c:/enlite/resource/project/Dsp.mdb</PropertyValue>
        </ResourceProperty>
        <ResourceProperty>
            <PropertyType>DSN_NAME</PropertyType>
            <PropertyValue>Product DSP</PropertyValue>
        </ResourceProperty>
        <Domain>DSP</Domain>
    </Resource>
    <Resource>
        <ResourceName>SIMPLE_ASIC_PROJECT_MDB</ResourceName>
        <ResourceType>PROJECT_ODBC_CONN_STRING</ResourceType>
        <ResourceProperty>
            <PropertyType>FILENAME</PropertyType>
    <PropertyValue>c:/enlite/resource/project/SimpleAsic.mdb</PropertyValue>
        </ResourceProperty>
        <ResourceProperty>
            <PropertyType>DSN_NAME</PropertyType>
            <PropertyValue>Project SimpleAsic</PropertyValue>
        </ResourceProperty>
        <Domain>DSP</Domain>
    </Resource>
</ResourceList>
```

As a final step in the configuration process, resources are mapped to instructions through a mapping table. An XML schema may be employed for such a mapping, and an illustrative, non-limiting example of such a schema is presented in Table 12.

```
TABLE 12
<?xml version=“1.0” encoding=“UTF-8”?>
<!-- edited with XML Spy v3.5 NT (http://www.xmlspy.com) by suthasankar (Enlite) -->
<ResourceMapList>
    <ResourceMap>
        <InstructionName>Get Dev Cost From MsProjectFile</InstructionName>
        <DomainName>DSP</DomainName>
        <ResourceName>DSP_MSPROJECT_FILE</ResourceName>
        <PeerName>enliteind1</PeerName>
    </ResourceMap>
    <ResourceMap>
        <InstructionName>Get Cap Cost From Purchasing Table</InstructionName>
        <DomainName>DSP</DomainName>
        <ResourceName>R&amp;D_PURCHASING_DB_TEXT_FILE</ResourceName>
        <PeerName>enliteind3</PeerName>
    </ResourceMap>
    <ResourceMap>
        <InstructionName>Get Estimated Product Cost From Budgeting
Table</InstructionName>
        <DomainName>DSP</DomainName>
        <ResourceName>R&amp;D_BUDGET_DB_TEXT_FILE</ResourceName>
        <PeerName>enliteind3</PeerName>
    </ResourceMap>
    <ResourceMap>
        <InstructionName>Get percent complete from MS Project
File</InstructionName>
        <DomainName>DSP</DomainName>
        <ResourceName>DSP_MSPROJECT_FILE</ResourceName>
        <PeerName>enliteind3</PeerName>
    </ResourceMap>
    <ResourceMap>
        <InstructionName>Get percent complete from MS Project
File</InstructionName>
        <DomainName>DSP</DomainName>
        <ResourceName>SIMPLE_ASIC_PROJECT_MDB</ResourceName>
        <PeerName>enliteind1</PeerName>
    </ResourceMap>
</ResourceMapList>
```

In embodiments of the invention, the mapping also indicates the peer from which a given resource is accessible. Alternatively, the peer could be configured as part of the resource. Other method for configuring resources shall be apparent to those skilled in the art.

### Events Triggering ViewFlows

In embodiments of the invention, viewflows are triggered by events, which may be synchronous or asynchronous events. Examples of asynchronous triggering events may be entries to the system database or to client UI events, such as queries. Alternatively, scheduled synchronous events may also trigger the execution of viewflows, many examples of which shall be readily apparent to those skilled in the art. In either case, events are mapped to queries, which are subsequently mapped to cells and Viewflows and executed; cells populate themselves in response to events by running corresponding viewflows.

### Other Nodes in the Design Chain Management System

In addition to the above types of nodes (Viewflows and instructions), embodiments of the invention support additional types of nodes:

Branching or rule nodes.

Iterator nodes.

OR or sync nodes.

Amongst these types of nodes, branching nodes evaluate a condition and branch execution flow based on the result. As viewflows end in a single node, branches in a viewflow are ultimately synchronized or “OR”'d. Furthermore, in embodiments of the invention, Viewflows may be iterated over domains. Thus a user could ask a query of a set of domains, and the results for all domains are aggregated and presented in response. These and other features of viewflow nodes are further elaborated in the U.S. Provisional application incorporated by reference herein.

### System Architecture of the Design Chain Management System

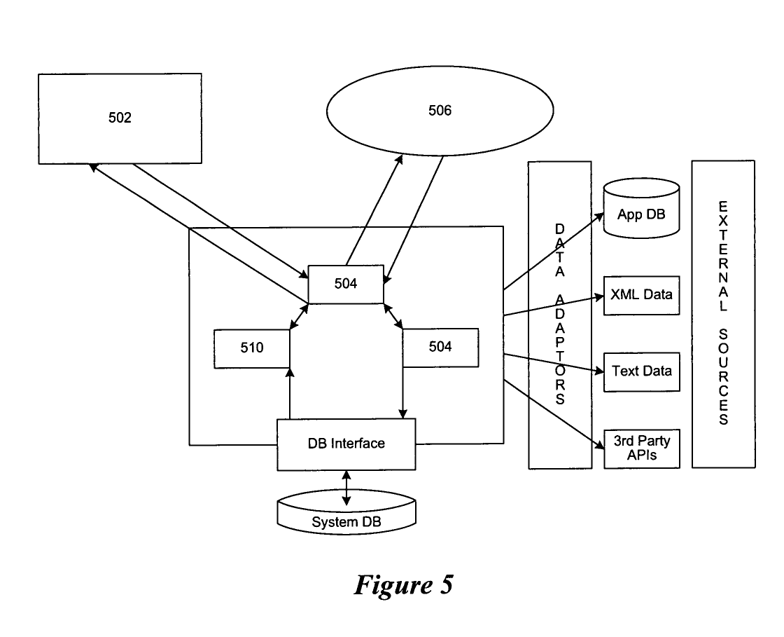

FIG. 5 depicts a system architecture used by embodiments of the invention to model a design chain through the execution of viewflows. The system includes a viewflow engine 502 which processes viewflows according to the execution techniques elaborated infra. An extractor 504 may accept requests synchronously or asynchronously as follows:
Synchronous requests from the ViewFlow engine 502. In this case the output returned after the extraction requests are in the form of data objects.
Asynchronous requests from the Event Queue 506. The extractor 504 logs an Extraction Completed/Failure Event to the event queue after the extraction is done. If the extraction completed successfully the DataObject(s) returned are in the form of Event Objects.

Additional, components of the design chain management architecture depicted in FIG. 5 include a database for the viewflows and data objects. Embodiments of the invention further include aggregators for assembling information from diverse sources. The ViewFlow engine 502 automatically aggregates results from multiple predecessor nodes and feeds them to successor nodes. Embodiments of the invention also support more complex aggregation operations, in which data from multiple dataobjects are entered into a single dataobject.

1. A method of monitoring an electronic design project, the method comprising:
upon the occurrence of one or more triggering events, extracting parameters on the electronic design project from two or more software resources, the two or more software resources including an issue tracking tool, a project management tool, and an ERP tool;
in response to extracting the parameters, determining an actual development cost of the electronic design project;
upon extracting the parameters, determining an estimated cost of the design project;
from one or more of the extracted parameters, determining progress of the design project as a percentage;
comparing the actual development cost, as a percentage of the estimated cost, to the percentage of the progress of the design project.

2. The method of claim 1, further including:
displaying results of the comparing the actual development cost on a user interface.
